(19) United States
(12) Patent Application Publication
(10) Pub. No.: US 2007/0262950 A1
(43) Pub. Date: Nov. 15, 2007

(54) Mobile communication device with automatic image-changing functions

(75) Inventors: Cheng-Shing Lai, Taipei (TW); Wei Zhang, Nanking City (CN)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/430,837

(22) Filed: May 10, 2006

(51) Int. Cl. G09G 5/00

(52) U.S. Cl. 345/156

(57) ABSTRACT

This invention is relative to a mobile communication device with automatic image-changing functions. Users can use these automatic image-changing functions to choose their favorite background images from a database, and set it to appear, right away or on scheduled time, randomly or in a pre-specified serial order, on the display screen of the mobile communication device. When a built-in timer detects a set time for changing images, the device then selects the image specified to be displayed at that time interval from the database through an image-changing module, and then sends it to the display screen. Also, the image-changing module allows the user to change the images at random or let the module automatically change them in pre-specified serial order.

### BACKGROUND OF THE INVENTION

1. Field of the Invention

The present invention is relative to a mobile communication device, particularly to that with automatic image-changing functions.

2. Description of the Prior Art

As mobile phones become more and more popular, and manufacturers are vying with others for customers, all value-added kinds, often have to be personalized and features have to be added to this little device to win the hearts of consumers. These personalized features generally fall in the three major categories: 1. physical designs, 2. ringing patterns, and 3. on-screen displaying.

The screen of a mobile communication device is used for displaying images. Generally speaking, these images fall in two categories: those carrying messages and those forming the background of a message or image displaying.

When a mobile communication device is in a running mode, the display screen thereof shows message-carrying images. When it is in an idle mode, the display screen simply shows background images.

FIG. 1 shows a schematic diagram of a conventional mobile communication device. The conventional mobile communication device 1 displays background images and message-carrying images on a display screen 2. The background images are pre-stored in the database of the mobile communication device representing a set of data. Before the mobile communication device displays a background image, it will retrieve the corresponding data from the database, convert the corresponding data into an image, and then show the image on the display screen 2. If the user 4 needs to change the background image, he or she has to use an image-changing interface 5.

The image-changing interface 5 consists of a switch button 6, and an image-changing module 7. The user 4 has to enter his commands through the switch button 6, and view the processing status through the display screen 2 at the same time. For setting an image, he presses the switch button after choosing an image, and then the image-changing module 7 will pick up the set of data corresponding to the desired image from the database. The set of data is then loaded onto the display screen and the user can see his desired image.

This is really a clumsy process for the user to set an image unless an added feature of changing background images is included.

As such, the major object of this invention is to provide the user with a better communication device that incorporates better value-added features, not only with the automatic image changing function, but also with the data transmitting and receiving capability.

### SUMMARY OF THE INVENTION

An object of the present invention is to provide the user with a communication device that incorporates automatic image changing functions. The user may set or preset a set of data via a database, a timer, and an image-changing module, so that the device can change background images automatically, either randomly or in a preset sequence.

The present invention provides the mobile communication device with automatic image changing functions. Through the display screen and the control module wider varieties of background image for the mobile communication device can be provided and, hence, the added value of the mobile communication device will be increased.

The invention also provides the mobile communication device with a positioning function via a positioning module, the mobile communication device can show the environment image on the display screen, thus the user is more familiar with the present location.

The invention is relative to a mobile communication device with automatic image changing functions. The device contains a display screen, a display control module, a database, a timer, and an image-changing module.

The display screen is used for showing background images, and the display control module is used for controlling a display mode of said at least a background image on the display screen. The display modes (or patterns) consist of the appearing format of images and the fixedly-displaying format.

The database is used for storing the data corresponding to a series of images. The timer times the image changing occurring at an end of a predetermined interval of time for automatic image changing. When the timer detects the preset interval of time for changing images, the image-changing module then selects a background image and loads it onto the display screen from the database. Also, via pre-setting the image-changing module the user can automatically change the images randomly or in a preset sequence.

### BRIEF DESCRIPTION OF THE DRAWINGS

FIG. 1 shows a schematic diagram of a conventional mobile communication device.

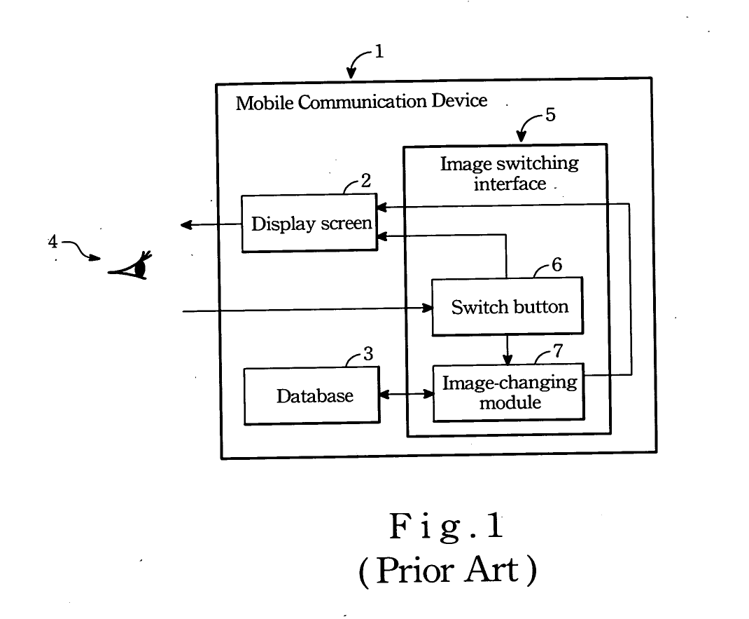

FIG. 2 shows a schematic diagram of a mobile communication device with automatic image-changing functions according to the present invention.

FIG. 3 shows a schematic diagram of a mobile communication device with a positioning module according to the present invention.

FIG. 4 shows a schematic diagram of a mobile communication device including a positioning module, an image data searching module and an internet connection module according to the present invention.

FIG. 5 shows the positioning module of the present invention and how the position of the mobile communication is identified.

### DESCRIPTION OF THE PREFERRED EMBODIMENT

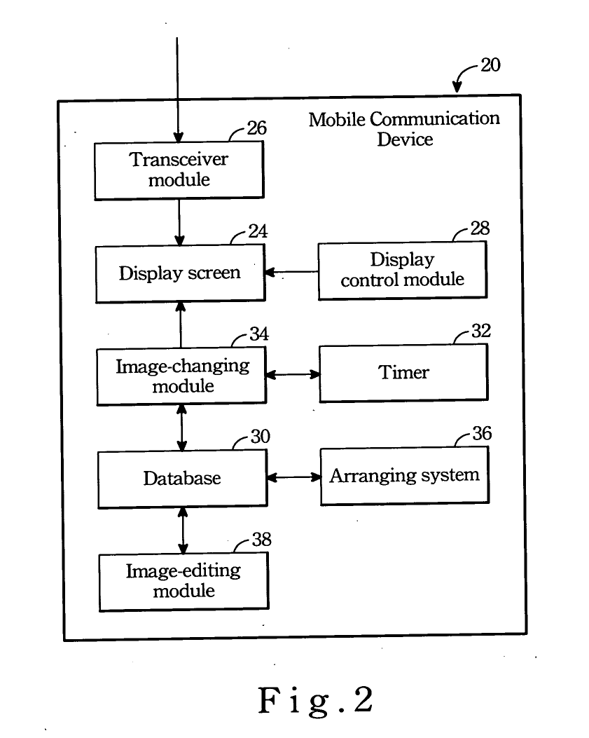

FIG. 2 illustrates a schematic diagram of a mobile communication device with automatic image-changing functions according to the present invention. The mobile communication device 20 transmits and receives messages through a transceiver module 26, and displays images through a display screen 24. The images generally fall into two categories: those carrying information messages and those forming the background images. Those images that the transceiver module 26 sends and receives information are message-carrying images; those forming the background for the message-carrying images, as well as those displayed when the mobile communication device 20 is in an idle mode are background images.

The invention is relative to a mobile communication device 20 with automatic image-changing functions. The mobile communication device 20 contains a display screen 24, a display control module 28, a database 30, a timer 32, an image-changing module 34, an arranging system 36, and an image-editing module 38.

According to the invention, the display screen is used to show background images, while the display control module is used to control the display modes or patterns of background images. The display modes or patterns are classified into two categories: 1. the animation scheme and 2. the configuration.

The animation scheme is the way how images appear on the display screen. These may include: pop-up images suddenly showing up on the screen, flying-in images flying in from one side of the screen, shuttering the screen as a blind, and dividing the screen into several grids. For example, an image appear by “flying” in from one side of each grid, then the image of the previous page may disappear from the screen by a dissolving-in mode, and the next image will immediately show up by a flashing mode or in a whirling manner. Other appearing modes of image are practically much the same as the animation features of Microsoft Power Point such as the spiral mode, the shrinking mode and stretching-out mode.

Furthermore, via the display control module 28, the user can also choose or change the way how images are displayed on the screen 24. More than one image can be shown simultaneously on the screen. The configuration can be a “stack” of images piled up according to a serial order or just randomly, or be several arrays of uniform segmentation images aligned or distorted on each border.

The database 30 is used for storing images made in advance. The timer 32 is used to time the image changing occurring at an end of a predetermined interval of time. The time interval can be set for a minute, an hour, a day, a month, etc. If the timer detects a set time for changing images, the image-changing module 34 then selects the image specified to be displayed at that time interval from the database, and then sends it to the display screen 24. The image-changing module 34 allows the images to be changed randomly or in a pre-specified serial order.

The pre-specified serial order is produced by an arranging system 36 in the mobile communication device 20. The arranging system 36 can be used to arrange the information of background images in the database and generating a serial order of the background images such that the image-changing module changes the background images to be displayed on the display screen according to the order. The image-changing module 34 will then change the background images according to the pre-specified serial order.

Besides, the user can use a built-in an image-editing module 38 to edit the image information. The image-editing module 38 can acquire data from image-creating devices such as digital cameras or digital video recorders, or from image-editing software as Photoshop, CorelDraw etc., and, after editing images, store the image information in the database 30. The following is a description about the entire process to change background images on display for the mobile communication device 20. The process includes the following steps: storing background images in the database 30, editing collected image data by using the image-editing module 38 and then storing these edited image data in the database 30 for future use.

Then the user can use the screen display module 28 to control the background images appearing on the display screen 24.

Users can use these automatic image-changing functions to choose their favorite background images from a database, and set it to appear, right away or on scheduled time, randomly or in a pre-specified serial order, on the display screen 24 of the mobile communication device.

When a built-in timer detects a set time for changing images, the device then selects the image specified to be displayed at that time interval from the database through an image-changing module, and then sends it to the display screen 24. Also, the image-changing module allows the user to change the images randomly or in a pre-specified serial order.

The user can also use the aforesaid display control module 28 to control the background images appearing on the display screen 24 i.e., how they are regularly shown on the screen in a certain format. The display modes may include: pop-up images suddenly showing up on the screen, flying-in images flying in from one side of the screen, shuttering the screen as a blind, and dividing the screen into several grids. For example, an image appear by “flying in” from one side of each grid, then the image of the previous page may disappear from the screen by a dissolving-in mode, and the next image will immediately show up by a flashing mode or in a whirling manner. Other appearing modes of image are practically much the same as the animation features of Microsoft Power Point such as the spiral mode, the shrinking mode and stretching-out mode.

The regular-display mode may include the following formats: a “stack” of images piled up according to a serial order or just randomly, or be several arrays of uniform segmentation images aligned or distorted on each border.

The user can also use the built-in timer 32 to time the image changing occurring at an end of a predetermined interval of time for automatic image changing. When the timer 32 detects a set time for changing images, the image-changing module 34 then selects the image specified to be displayed at that time interval from the database 30, and then sends it to the display screen 24. Also, through the image-changing module the user can change the images randomly or in a pre-specified serial order.

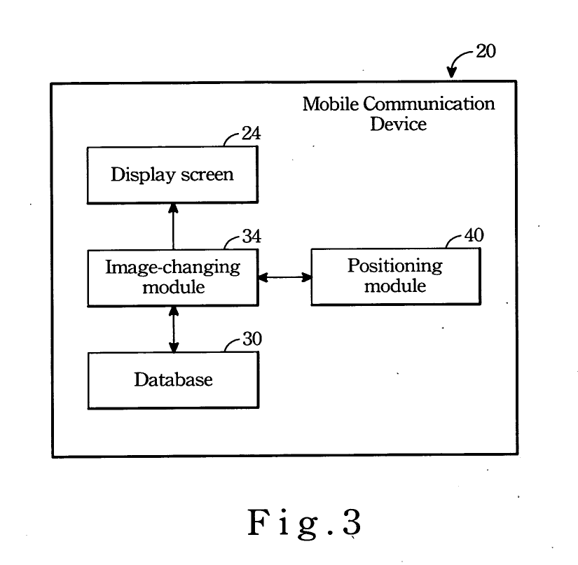

FIG. 3 illustrates a schematic diagram of a mobile communication device with a positioning module according to the present invention. As mentioned before, the mobile communication device includes a built-in positioning module 40. The positioning module 40 is used for locating the geographical position of the mobile communication device. A position of the mobile communication device, whereby information, stored in the database, of said at least a background image associated with the position is used for displaying on the display screen. By identifying the position of the mobile communication device, the user can pick up associated image data from the database 30 through the image-changing module 34 and then process all the steps as described above according to FIG. 2, so that the display screen 24 shows the right images chosen by the user.

After picking up image data from the database 30, the image-changing module 34 can search associated geographical data through an internet connection and then store them in the database 30.

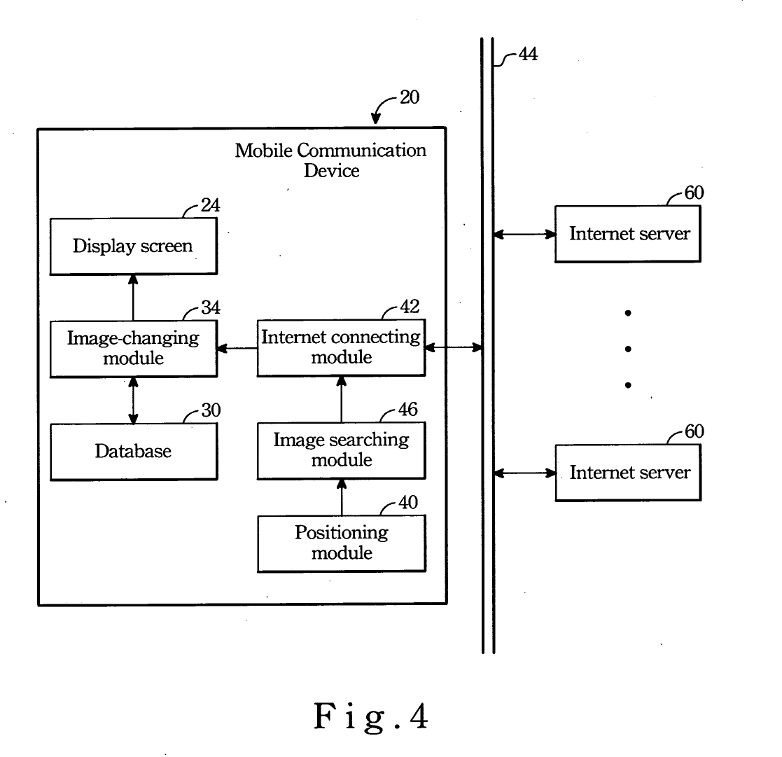

FIG. 4 illustrates how the mobile communication device searches associated geographical data through an internet 44 connection. After the positioning module 40 identifies the geographical position of the mobile communication device, it immediately generates a geographical name corresponding to the position of the mobile communication device. For example, if the mobile communication device is located in the Taipei City, the produced geographical name will be “Taipei”. Through a built-in internet-connecting module 42 in the mobile communication device 20, the mobile communication device 20 is then connected to more than one internet server 60. A built-in image-searching module 46 in the mobile communication device 20 is used to search for geographical image data in the internet servers 60 according to the geographical name through the internet 44 and store the geographical image data in the database for displaying the background image corresponding to the geographical image data.

The positioning module in the aforesaid mobile communication device 20 can be a global positioning system module (GPS). The GPS can identify the exact geographical position of the mobile communication device through satellites. As the operation of GPS is already well-known, thus the relative descriptions in detail are skipped.

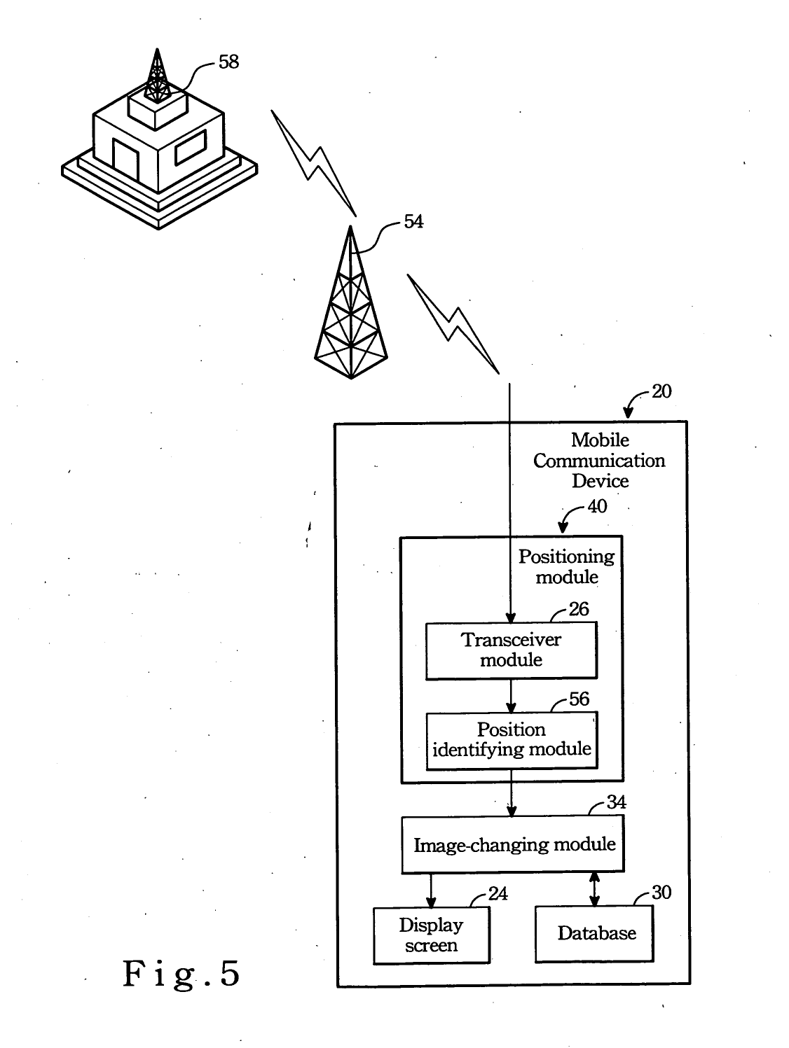

Refer to FIG. 5, besides the aforementioned method, there is another way of first locating the position of the central routing unit 54 to identify the position of the mobile communication device 20. The mobile communication device contains, as an optional feature, a transceiver module 26 and a position-identifying module 56. The transceiver module 26 is used to provide wireless connections with at least one central routing unit 54, while the position-identifying module 56 is used to locate and identify the position of the central routing unit 54. After the mobile communication device 20 gets connected with the central routing unit 54, signals can be transmitted between the routing unit and the telecommunication service provider 58. Through the telecommunication service provider 58, the position of the central routing unit, and later the position of the aforesaid mobile communication device, can be identified. The images corresponding to the position of the mobile communication device can thus be stored in the database 30 and, later, to be used by the aforesaid image-changing module 34, which then sends it to the aforesaid display screen 24.

The object of this position-identifying feature, as described and illustrated in FIG. 3, 4, 5, is to provide the mobile communication device 20 with an additional function utilizing today's powerful communication technology well—not only giving eye-pleasing and fun images to the device 20, but also meaningful, geographical position-dependent images that carry useful information for the user. This is indeed a very desirable added-value.

The descriptions given above are just examples given to illustrate the embodiment of this invention. It does not necessarily follow that they are all what the invention can do, and applications of the invention shouldn't be limited, either explicit or implicit, just to the statements made above.

What is claimed is:

1. A mobile communication device capable of automatically changing at least a background image, the mobile communication device comprising:
a display screen for displaying said at least a background image;
a database for storing information of said at least a background image;
a timer timing the image changing occurring at an end of a predetermined interval of time; and
a image-changing module for automatically changing, at the end of the predetermined interval of time, said at least a background image to be displayed on the display screen.

2. The mobile communication device of claim 1, further comprising a display control module for controlling a display mode of said at least a background image on the display screen.

3. The mobile communication device of claim 1, wherein the image-changing module changes said at least a background image randomly.

4. The mobile communication device of claim 1, further comprising an arranging system for arranging the information of said at least a background image in the database and generating a sequence of said at least a background image such that the image-changing module changes said at least a background image to be displayed on the display screen according to the sequence.

5. The mobile communication device of claim 1, further comprising an image-editing module used to edit the information of said at least a background image in the database.

6. The mobile communication device of claim 2, wherein the display mode comprises configuring or animating said at least a background image.

7. The mobile communication device of claim 6, wherein the animation scheme is selected from a group consisting of appearing, flying-in effect, blind effect, checkerboard, dissolving-in effect, flashing, spiral, shrinking and stretching-out effect.

8. The mobile communication device of claim 6, wherein the configuration is selected from a group consisting of order-stacking, random-stacking, uniform segmentation, non-uniform segmentation and distortion.

9. The mobile communication device of claim 1, further comprising a positioning module for locating a position of the mobile communication device, whereby information, stored in the database, of said at least a background image associated with the position is used for displaying on the display screen.

10. The mobile communication device of claim 9, wherein the positioning module is a Global Positioning System GPS.

11. The mobile communication device of claim 9, wherein the positioning module comprises:
a transceiver module for communicating with at least a base station; and a position-identifying module for identifying a position of the base station.

12. The mobile communication device of claim 11, wherein the positioning module generates a geographical name corresponding to the position of the mobile communication device after the position-identifying module identifies the position of the base station.

13. The mobile communication device of claim 12, further comprising:
an internet-connecting module for connecting to an internet; and
an image-searching module used to search for geographical image data according to the geographical name through the internet and store the geographical image data in the database for displaying said at least a background image corresponding to the geographical image data.
